(19) United States
(12) Patent Application Publication
(10) Pub. No.: US 2017/0083186 A1
(43) Pub. Date: Mar. 23, 2017

(54) GUI for Generating and Viewing Electronic Invitations

(71) Applicant: Minted, LLC, San Francisco, CA (US)

(72) Inventors: MARIAM B NAFICY, San Francisco, CA (US); Erica Meade, Berkley, CA (US); Douglas Frederick Aley, Greenbrae, CA (US); Chun-Wei Lien, San Jose, CA (US)

(73) Assignee: Minted, LLC, San Francisco, CA (US)

(21) Appl. No.: 15/271,289

(22) Filed: Sep. 21, 2016

Related U.S. Application Data
(60) Provisional application No. 62/221,811, filed on Sep. 22, 2015.

(51) Int. Cl. G06F 3/0482; G06F 9/44; G06F 3/0483; G06F 3/0485

(52) U.S. Cl. CPC G06F 3/0482; G06F 3/0485; G06F 9/4443; G06F 3/0483

(57) ABSTRACT

A graphical user interface (GUI) displays a scene on a display screen of a communication device. The scene includes an image of a background, an image of an invitation in front of the background, an image of a three-dimensional ancillary item in front of the background, and an image of a reply form in front of the background. The displaying includes panning across the scene such that the background, the ancillary item and the invitation appear to move along the screen. While the reply form is in the scene, input is received from a recipient of the invitation for the recipient to interact with the reply form to reply to the invitation.

### TECHNICAL FIELD

This application claims priority from U.S. Provisional Application No. 62/221,811, filed Sep. 22, 2015, hereby incorporated herein by reference.

### TECHNICAL FIELD

This relates to a graphical user interface (GUI) for generating an invitation and for electronically displaying the invitation.

### BACKGROUND

Websites of stationery vendors may enable a customer to select and customize a layout for an invitation card. The vendor prints the invitation cards that incorporate the selected-and-customized design, and ships the cards to the customer. The customer then mails the cards to people the customer wants to invite.

### SUMMARY

A graphical user interface (GUI) displays a scene on a display screen of a communication device. The scene includes an image of a background, an image of an invitation in front of the background, an image of a three-dimensional ancillary item in front of the background, and an image of a reply form in front of the background. The displaying includes panning across the scene such that the background, the ancillary item and the invitation appear to move along the screen. While the reply form is in the scene, input is received from a recipient of the invitation for the recipient to interact with the reply form to reply to the invitation.

### BRIEF DESCRIPTION OF THE DRAWINGS

FIG. 1 is a block diagram of an example system for generating and displaying an invitation.

FIG. 2 is a flow chart of a method implemented by the system, for generating a scene containing the invitation using a first graphical user interface (GUI), and for viewing the invitation using a second GUI.

FIG. 3 shows an example image upload window of the first GUI.

FIG. 4 shows an example invitation selection window of the first GUI, for selecting and customizing the invitation.

FIG. 5 shows a scene selection window of the first GUI, for selecting and customizing a background scene to be displayed with the invitation.

FIG. 6 is a reply form selection window of the first GUI, for selecting and customizing a reply form to be displayed with the invitation.

FIG. 7 is a compositing window of the first GUI, for generating a composite scene in which the selected invitation and the selected reply form are added to the selected background scene.

FIG. 8 is a recipient list window of the first GUI, for designating intended recipients of the invitation.

FIG. 9 is a display of an example message that includes a link for initiating displaying of the composite scene.

FIG. 10 is story-board diagram illustrating one example procedure for displaying the composite scene on the second GUI.

FIG. 11 is story-board diagram illustrating another example procedure for displaying the composite scene on the second GUI.

FIGS. 12-14 are example composite scenes that may be produced, by the procedure, from background scenes shown in FIG. 5.

### DETAILED DESCRIPTION

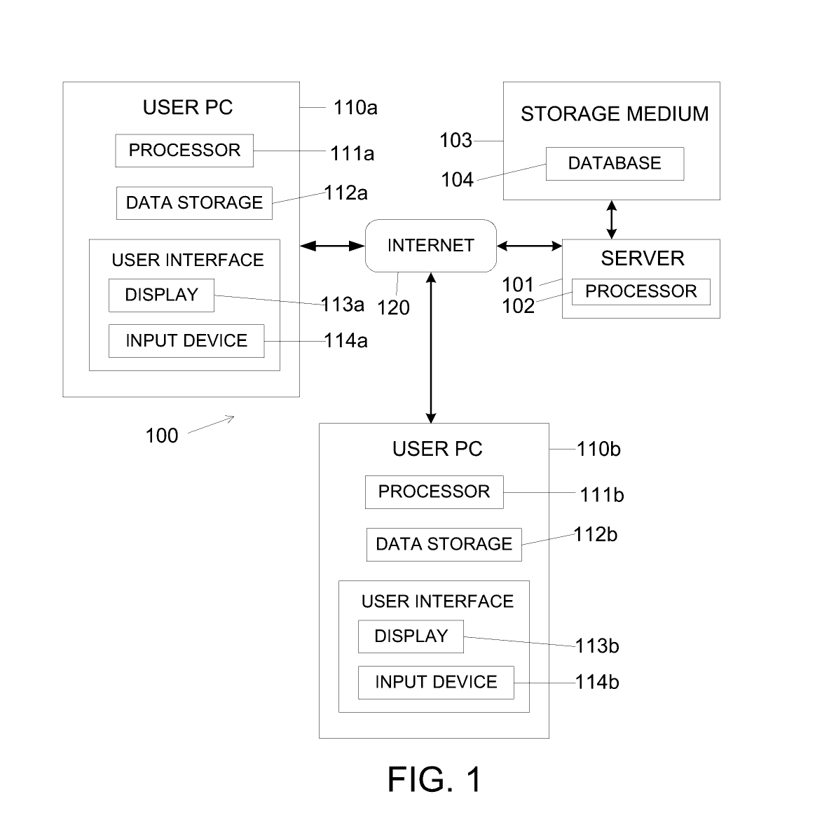

FIG. 1 is a block diagram of an example system 100 for implementing a method described below. In this method, a first user uses a first graphical user interface (GUI) to select and customize an invitation, a background scene and a virtual reply (RSVP) form. A composite scene is generated by adding the invitation and the reply form to the background scene. A message, including a link to the scene, is sent to a second user. When the second user activates the link, a second GUI displays the composite scene to the second user and enables the second user to fill out the reply form in the scene.

The example system 100 includes a non-transitory hardware server 101 that has a processor 102 (which can represent multiple processors). The processor 102 executes program instructions of software code. The code is stored on a non-transitory hardware computer-readable data storage medium 103, such as a computer hard drive device, to implement the functions of the server 101. The server 101 in this example hosts a website that provides the first GUI. The website is associated with a greeting card vendor (merchant, manufacturer). The storage medium 103 includes a database 104 that stores images and text provided by the first user. The database 104 also stores design templates for invitation cards and reply forms.

The first and second GUIs in this example are provided, respectively, on a first communication device 110a of the first user and a second communication device 110b of the second user. Examples communication devices 110a, 110b are a personal computer (PC) and a mobile communication device such as a smart phone. Each communication device 110a, 110b has a processor 111a, 111b for executing software commands and a non-transitory hardware processor-readable data storage medium 112a, 112b for storing the commands. Each communication device 110a, 110b also has a user interface that includes a display screen 113a, 113b and a user input device 114a, 114b for implementing the respective GUI. The input device 114a, 114b may include a mouse, a keypad and a touch-screen for inputting user entries. Each communication device 110a, 110b may communicate with the server 101 through a communication network such as the Internet 120.

Some or all of the software code for implementing each GUI may be stored at and executed by the server 101. The remainder of the software code for implementing the respective GUI may be stored in and executed by the respective communication device 110a, 110b. Alternatively, all of the software code for implementing the respective GUI may be stored in and executed by the respective user device 110a, 110b, such that a server is unnecessary. For example, the first communication device 110a might send the invitation through the Internet 120 without use of the server 120.

The invitation is to an event. Example events are a party (e.g., for a birthday, wedding, graduation), a meeting (e.g., business meeting for a business, committee meeting for an organization), a rally (e.g., political), a dinner (e.g., with a friend at the first user's home or at a restaurant), and a concert.

The first user in this example is both a sender and an inviter, in that the first user arranges for the system 100 to send the invitation to invite the second user to the event.

The second user in this example is both a recipient and an invitee, in that the second user is a recipient of the invitation. The number of invitees receiving the invitation may be any number. There might be only one invitee in a scenario in which the inviter is inviting one friend to dinner. There might be thousands of invitees in a scenario in which the inviter is inviting people to a rally.

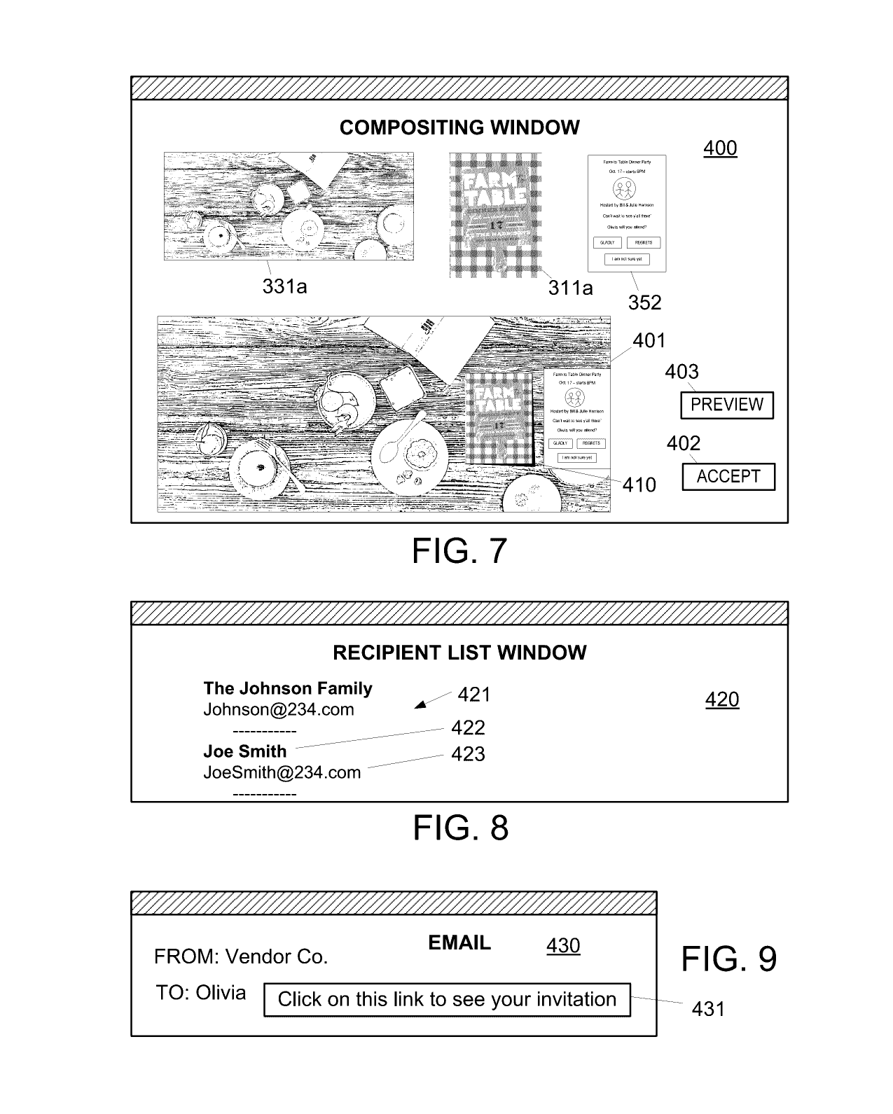

The invitation in this example is in the form of a realistic virtual card. “Virtual” in that it is seen by both the inviter and the invitee in a respective (i.e., first and second) GUI on the respective communication device's display screen. And “realistic” (photorealistic) in that it appears (to the invitee and/or the inviter) as a photograph of a real card made of paper stock. The realism might be reinforced by the respective GUI portraying the card's surface texture, grain, shadow, viewing-angle effects, and tilt. Examples of different textures are glossy, matte, smooth and grainy (e.g., grain of the paper stock). An example of portraying shadow is portray shadow made by the card against a background surface (such as shadow 410 in FIG. 7). An example of a viewing-angle effect (perspective-dependent effect) is visibility of the thickness of one or two side edges of the card but lack of visibility of the thickness of other edges of the card. An example of portraying tilt might be by the card appearing to be tilted away from the viewer, such as by standing substantially vertically on a horizontal surface (e.g., tabletop) and leaning rearward against a vertical surface (e.g., wall).

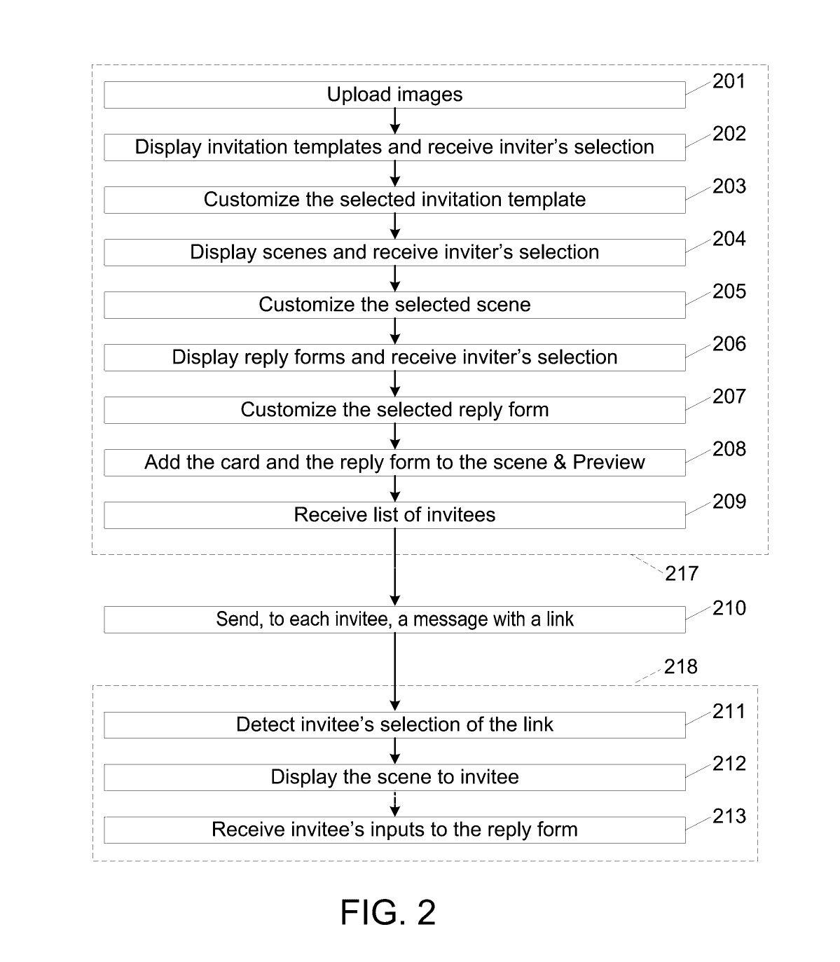

FIG. 2 is a flow chart of an example method performed by the system 100. Steps 201-209 (encircled by dashed box 217) are performed by (e.g., completely by, partially by, through direction of, or through assistance of) the first GUI. Steps 211-213 (encircled by dashed box 218) are performed by (e.g., completely by, partially by, through direction of, or through assistance of) the second GUI. Step 210 might be performed by the first GUI or the server 101. In this method, the system 100 uploads the inviter's images 201, displays a variety of templates of virtual invitation cards and receives the inviter's selection of one of the cards 202, receives the inviter's selections (designations) for customizing the card 203, displays a variety of scenes to the inviter and receives the inviter's selection of one of the scenes 204, receives the inviter's selections for customizing the scene 205, displays a variety of reply forms to the inviter and receives the inviter's selection of one of the reply forms 206, receives the inviter's selections for customizing the reply form 207, adds the selected-and-customized card and the selected-and-customized reply form to the scene to yield a composited scene and preview the composited scene 208, receives an invitation list of invitees from the first user 209, sends to each invitee a message that includes a link for opening the scene 210, detects the invitee's selection of the link 211, displays the scene to the invitee 212, and receives the invitee's inputs to the reply form 213.

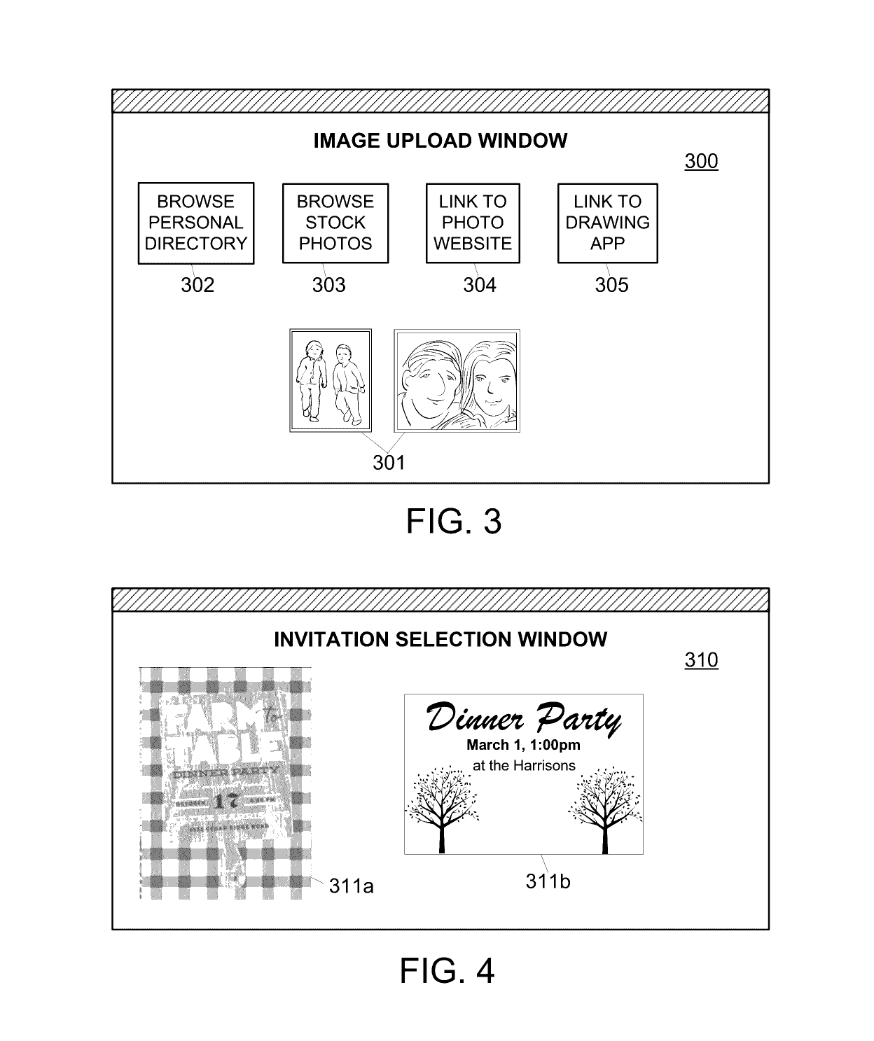

FIG. 3 shows an example Image Upload Window 300 (screen) of the first GUI. This window 300 is used by the inviter to upload (step 201 in FIG. 2) one or more images 301 (e.g., photos) to be inserted in (appear in) the invitation, the reply form or the background scene. Clicking on a “Browse Personal Directory” icon 302 in the window 300 accesses the user's computer directory, from which the user may select one or more images to upload to the website server 101. Clicking on a “Browse Stock Images” icon 303 in the window 300 causes the first GUI to display a variety of stock images (e.g., photos) that are stored in the server 101, from which the user may select one or more stock images. Clicking on an external-website link 304 in the window 300 opens another website that has images, such as a website that holds the user's personal photographs, for the user to import images from the other website into the image designation window 300 of the present website. Clicking on an image application link 305 opens an image-containing and/or image-generating application on the user's own device, from which images can be imported. The user may also copy-and-paste images, or drag-and-drop images, from other websites, or from other applications on the user's device, into the window 300.

The inviter might upload, into the Image Upload Window 300, a file containing moving content, such as a video or animated image. For example, if the event is a birthday for a child, the video file or animated file might show the child moving. The first GUI might extract, from the video/animated file, a still image of the child to use in the composited scene. Or the first GUI might use the video/animated file as is, such that the child will appear to be moving in the final composited scene.

FIG. 4 shows an example Invitation Selection Window 310 (screen) of the first GUI. This window 310 displays different invitation templates 311a, 311b for the user to choose from (step 202). Each template may include text and non-text ornamentation. The text may include a general description of the event (e.g., “Farm to Table dinner party”), a time and date, a location (e.g., “at the Harrisons”), and other details about the event. The text may be rendered in an ornamental fashion, such as rendered in a script font or rendered by calligraphy. The non-text ornamentation may include a background (such as plaid background in 311a) and one or more ornamental features (kitchen cutting board in 311a). The background extends across a substantial portion of the height and width of the card. The inviter may select one of the invitations by clicking on it (e.g., by a mouse) or touching it (e.g., if a touch screen).

Before or after selecting the invitation, the inviter may use the Invitation Selection Window 310 in the first GUI to customize the invitation (step 203). This customizing might be done by the user sweeping a mouse across (swiping) a passage (section) of text to highlight the passage, and typing (e.g., by using a keypad) text that will replace the passage. The GUI may also enable the inviter to revise the font and size in which each text passage is rendered. This might be done by right-clicking on a text passage to open a formatting window from which to select a font and size for the passage. The first GUI may also enable the inviter to move each text passage to a different location on the invitation 311a. This might be done by clicking and dragging the respective text passage. The first GUI may also enable the user to insert one or more of the user-uploaded images 301 into the invitation 311a. This might be done by clicking-and-dragging the uploaded image 301 to a desired location on the invitation 311a. The first GUI may enable the inviter to select the color scheme and color tone of the invitation 311a as well as the shape of the invitation card itself (die cut shape).

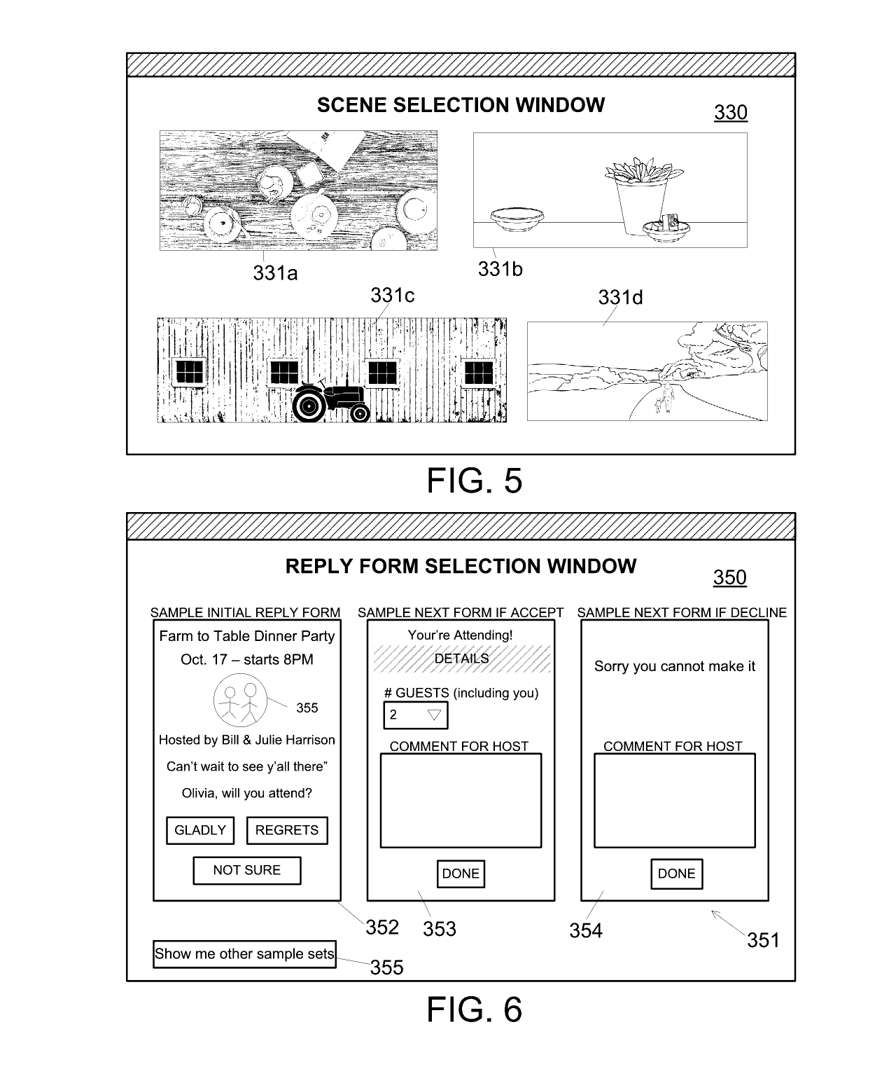

FIG. 5 shows an example Scene Selection Window 330 (screen) of the first GUI. This window 330 displays different sample (candidate) background scenes 331a-331d for the user to choose from (step 204). Each scene includes at least one image of a background. In scenes 331a, 331b, 331c and 331d, the background is respectively a tabletop, a combination tabletop and wall in a room, an outside wall of a barn, and a landscape. Each background scene may be obtained by photographing or filming an actual (live) scene, for example by photographing an actual barn or an actual landscape.

Each scene further includes at least one image of a three-dimensional ancillary item in front of the background (i.e., between the background and the viewer). The ancillary item is ancillary in that it is other than the invitation. The ancillary item may be related or unrelated to the invitation and related or unrelated to the event. Scene 331a has many such ancillary items, which include plates of food, a box of berries and a napkin, with each ancillary item spaced away from (separated from) each other ancillary item in the view. The ancillary items in scene 331b include a potted plant, a bowl of food and an empty bowl. In scene 331c, the ancillary items is a tractor. In scene 331d, the ancillary item includes people. In another example, the background might be a marquee of a theater, and the invitation might be in the form of lettering on the marquee. The inviter may select one of the scenes 331a-331d by clicking on it (e.g., with a mouse) or touching it (e.g., with a touch screen).

The inviter may use the Scene Selection Window 330 in the first GUI to customize the scene (step 205). This customizing may include inserting one or more of the user-uploaded images into the scene. An example of an uploaded image to be inserted into the scene, if the event is a birthday, is an image of a child whose birthday it is—or what would appear (in the scene) to be an image of a photograph of the child. The first GUI may also enable the user to insert a video (movie clip, animation) into the scene. An example of an uploaded clip to be inserted into the scene is a video of a child whose birthday it is. So that child would appear to be both present in the scene and moving in the scene displayed by the second GUI to the invitee. The image of an ancillary item might be an image of a display device, such as a television, that is appearing to be displaying a movie clip (video) that is provided by the inviter. For example, if the event is a birthday, the television in the scene may be showing a movie clip of the child whose birthday it is.

In this example, the candidate background scenes (for the user to choose from) are provided by the vendor. Alternatively, the background may be provided by the inviter. For example, the inviter may upload an image to be used as the scene. The image might be drawn or otherwise-rendered by the inviter to appear as a 3-dimensional environment. Or the inviter may upload a video clip or animated GIF file. The animated GIF file might include a 3-dimensional-rendered environment. The first GUI might extract an image from the video or animated GIF file. Or the first GUI might use the video or animated GIF file as is, such that the scene includes moving/animated features.

FIG. 6 shows an example Reply Form Selection Window 350 (screen) of the first GUI. This window 350 enables the inviter to choose from a variety of sample (candidate) reply forms (step 206). Each sample reply form may ask a set of questions different than is asked by the other sample reply forms, and may display the questions in a different format (e.g., differing in font or phraseology) than displayed in the other sample forms, and may use different input methods (e.g., radio buttons versus text entry versus voice entry) for receiving the invitee's replies than the other sample reply forms.

Reply forms may exist in sets. One example set of reply forms is displayed by the Reply Form Selection Window 350 in FIG. 6. The sample set 351 includes (i) an initial form 352 for the invitee to indicate (e.g., by clicking on a virtual button) whether he/she will or will not attend or is not sure, (ii) a first follow-on form 353 to be filled out if the invitee accepts the invitation and (iii) a second follow-on form 354 to be filled out if the invitee declines. In this example, all forms (initial form and follow-on forms) of a single set are presented in a single window 350, and does not leave room to show other sample sets. The inviter may select an option (e.g., by clicking on a virtual button 355) for the window 350 to show another sample set of reply forms. And the inviter would choose one of the sample sets. Alternatively, the window 350 might show a variety of initial forms 352. The inviter may select one of the initial reply forms by clicking on it (e.g., by a mouse) or touching it (e.g., if a touch screen). And afterward, the window 350 would display the follow-on forms that are associated (in the database 104) with the selected initial reply form.

The inviter may use the Reply Form Selection Window 350 to customize each reply form (step 207), whether the reply is or is not the chosen one. This customizing might be done by the user sweeping a mouse (swiping) across a passage of text to highlight the passage of passage, and typing (e.g., by using a keypad) text that will replace the highlighted passage. The inviter might use the first GUI to revise the font and size in which each text passage is rendered. This might be done by right-clicking on a text passage to open a formatting window from which to select a font and size for the passage. The GUI may also enable the inviter to move each text passage and each virtual button and each reply field to a different location on the invitation. This might be done by selecting-and-dragging (clicking-and-dragging) the respective text passage or virtual button or reply field. The first GUI may also enable the user to insert one or more of the user-uploaded images into the reply form (image 356). This might be done by the inviter selecting-and-dragging one of the uploaded images to a desired location on the reply form.

FIG. 7 shows an example Compositing Window 400 of the first GUI. This window 400 displays the selected-and-customized background scene 331a, the selected-and-customized invitation 311a and the selected-and-customized reply form 352 (step 208). This window 400 also displays a composited scene 401, in which the invitation 311a and the reply form 352 are added into the scene background 331a. The inviter selects (e.g., clicks or touches) a virtual button 402 to indicate acceptance of the composited scene 401.

At any time during steps 201 through 209, the host might check out the work he/she has done so far. This might be done by opening an interactive “Preview” link, that can be included in any of the windows. In this example, a “Preview” link is part of and that instantly renders and animates any customization/edits the host has made to the invitation so far.

FIG. 8 shows an example Recipient List Window 420 (screen) of the first GUI. The inviter may enter, into this window 420, a list 421 of intended recipients (invitees) (step 209). The list might include each recipient's name 422 and contact address 423 (e.g., email address). The server 101 or first communication device 110a of the system 100 sends a message (e.g., email message) to each address on the recipient list (step 210).

FIG. 9 shows an example message 430, which includes a link 431. The respective invitee may click on the link 431 (step 211) to initiate displaying of the composited scene 401 by the second GUI, which might include a web browser. Initiating the display may entail opening a file that is attached to the email itself and that includes the scene to be displayed. Alternatively, the link might link to a website address that downloads the scene to be displayed.

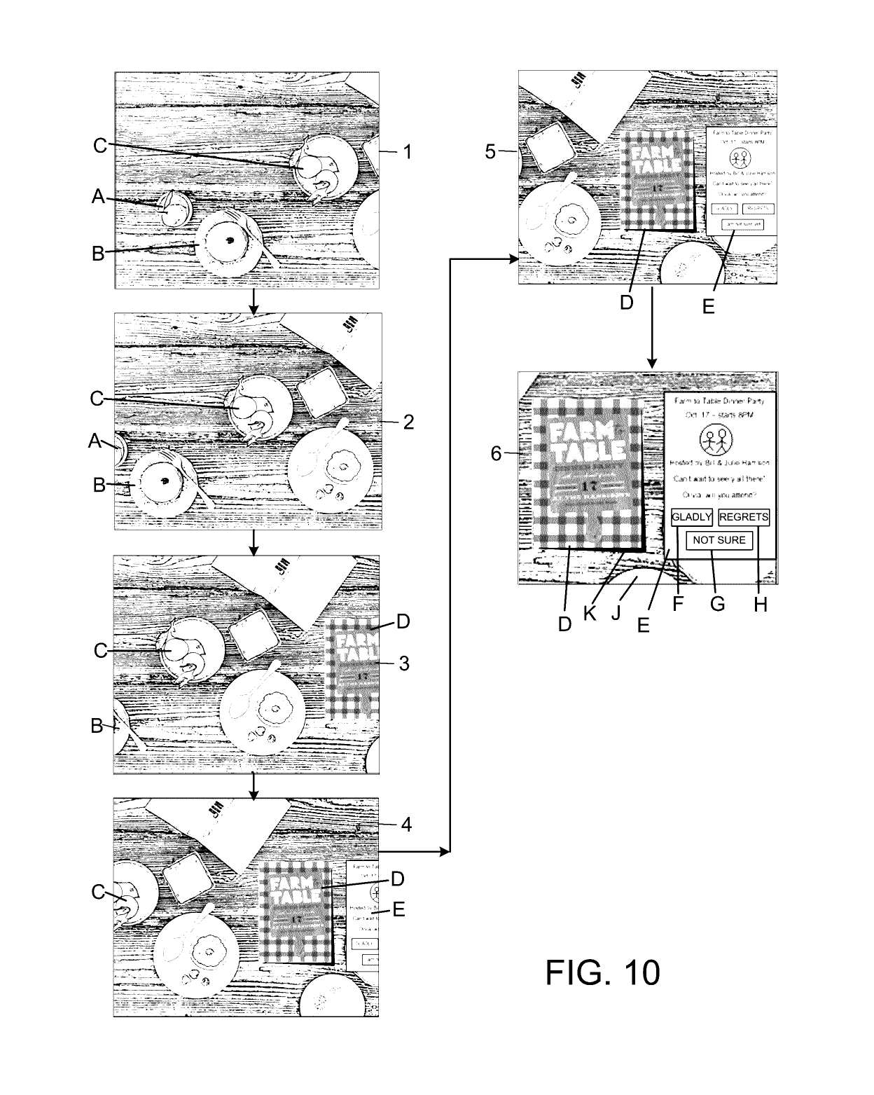

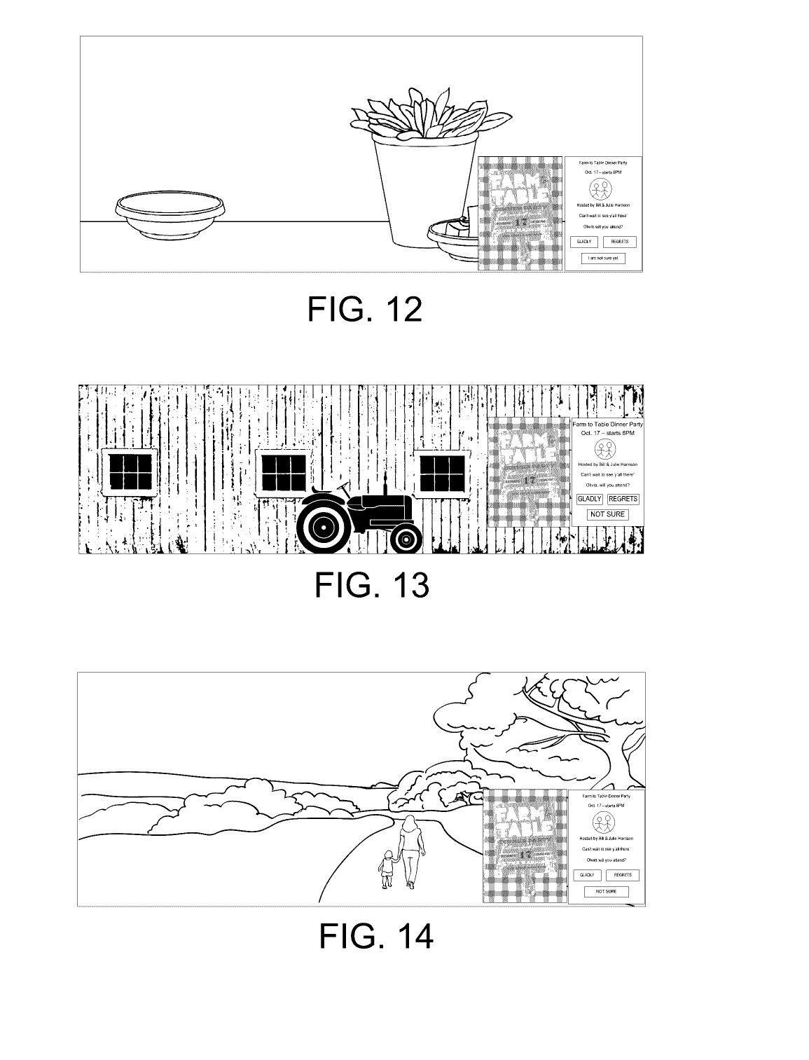

FIG. 10 is a storyboard diagram illustrating an example of what the invitee might see on the second GUI on the display screen 113b of the invitee's communication device 110b. The second GUI displays what appears as a video clip (animation) of the composited scene 401 (FIG. 8), which may be considered to comprise a series of frames, each frame spanning a different a field of view (FOV) that spans only a portion of the composite scene. The six frames shown in FIG. 12, numbered 1-6, are just a few reference frames of the many frames in the series. There might be more than ten frames between each of reference frames 1-6 (FIG. 12), and frames 1-6 (FIG. 12) may be displayed 0.5 to 2 seconds apart during the running video.

Frame 1 (FIG. 10) has a FOV spanning only a portion of the scene. From frame 1 through frame 5, the display pans rightward across the scene, such that the background (tabletop), the ancillary items (e.g., A, B and C), the invitation D and the reply form E appear to move horizontally leftward relative to the display screen 113b. Accordingly, each successive frame in the series, between reference frame 1 and reference frame 2, applies successive (though possibly imperceptible by eye) rightward-adjustment to the FOV. The FOV of each frame in the series spans only a portion of the scene.

By frame 3, ancillary item A has left the FOV, and a portion of the invitation D has entered the FOV. By frame 4, ancillary item B has left the FOV, and a portion of the reply form E has entered the FOV. By frame 5, ancillary item C has left the FOV, and both the invitation D and the reply form E are fully in the FOV. After frame 5, the display zooms in on the invitation D and the reply form E. This might be achieved by each successive frame (in the series), between frame 5 and frame 6, applying a successively (though possibly imperceptible by eye) increase to the zoom until reaching frame 6.

In frame 6, the second GUI enables the invitee to interact with the reply form by inputting (posting) a reply into the reply form E that is in frame 6. The input might be by the invitee selecting (by clicking or touching) one of three virtual buttons F, G, H (to respectively accept, decline or indicate not sure). The input might, if an alternate reply form were selected (by the inviter), include the invitee typing text into a reply field in the reply form. After input by the invitee, one or more follow-on reply forms may be displayed. For example, follow-on reply form 353 may be displayed and filled out if the invitee selects the accept button F. Alternatively, follow-on reply form 354 may be displayed and filled out if the invitee selects the decline button G. And some other follow-on reply form may be displayed and filled out if the invitee selects the “not sure” button H. Interaction by the invitee with the reply form includes the GUI, executed by the invitee's communication device 110b, receiving input (e.g., commands, selections and text) from the invitee.

The panning and zooming in this example, from frame 1 through frame 6, might occur without input by the recipient and as a smooth motion. The invitee's interaction with the reply form E might occur while the reply form E remains in the scene in frame 6, with the tabletop background and ancillary items (food plates J) and the invitation card D and even the invitation card's shadow K still visible.

In this example, the path and the speed (rate) of the panning are controlled by the system 100, and are out of control of the inviter and the invitee. In another example, the first GUI might enable the inviter to use the inviter's input device 114a (e.g., mouse, touch screen, keyboard) to control the path and speed of the panning that the invitee will see. Similarly, the second GUI might enable the invitee to use the invitee's input device 114b (e.g., mouse, touch screen, keyboard) to control the path and speed of the panning.

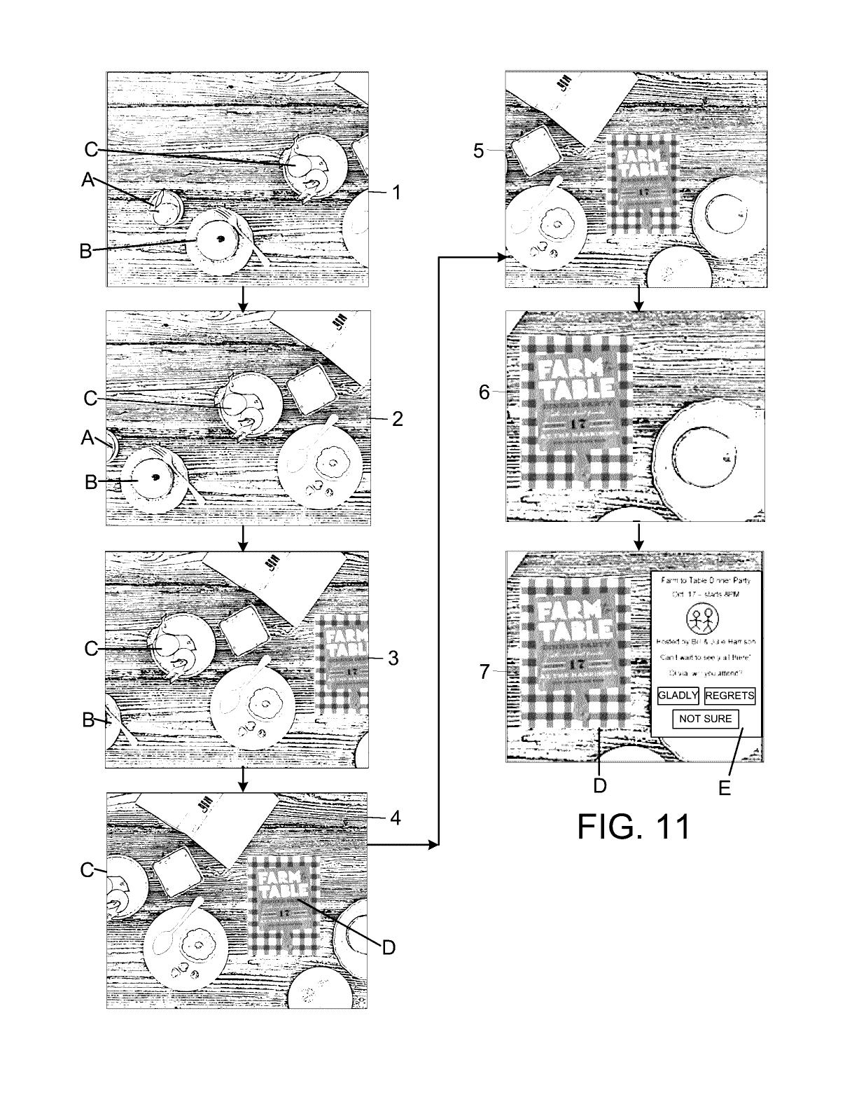

FIG. 11 is a storyboard diagram of an alternate example display sequence in which the reply form is absent from the scene until after frame 6. Frames 1-5 in FIG. 11 match frames 1-5 of FIG. 10. Whereas frame 6 in FIG. 10 shows the reply form resting on the table, frame 6 in FIG. 11 shows the tabletop without the reply form. In the sequence of FIG. 11, the reply form E appears on top of the table sometime between frame 6 and frame 7. The invitee may then input a reply into the reply form E at frame 7.

Different ways are possible for the second GUI to implement the panning-and-zooming display of FIGS. 10-11. For example, the scene might be downloaded to the invitee's communication device 110b as an image file containing a single frame (image), and the second GUI might be implemented by a web browser that is programmed (e.g., by html instruction code) to display only a portion of the single image scene at a time, and to gradually adjust the FOV of the single frame (image) over the course of time to achieve the panning and zooming described above. In such an implementation, the reference frames shown in FIGS. 10-11 are not different frames of a video clip, but instead different portions, of the same image, that appear at different times on display. Alternatively, the scene may be downloaded as a video file with a sequence of frames, with each frame spanning a different FOV.

The invitation, the reply form, the ancillary items and the background might change parallax with the panning across the scene. For example, a left side of an item but not the right side might be visible during frame 1, whereas the right side of the item but not the left might be visible during a later frame. The invitation or the ancillary item or the reply form might appear to move relative to the background when being displayed. Similarly, a portion (such as a branch of a tree in 331d) of the background might appear to move relative to another portion of the background.

In an alternate example, the invitation is in the form of written text, appearing as though handwritten using a writing instrument on the background (such as engraved into the tabletop of scene 401). And the image of the ancillary item is an image of the writing instrument.

FIGS. 12-14 show example composite scenes that may be generated by adding the selected invitation 311a (FIG. 8) and the selected reply form 352 to the background scenes 331b, 331c and 331d (FIG. 5), respectively. In FIG. 12, the background includes a horizontal surface, a tabletop, that appears to support the invitation and reply form by the invitation and reply form resting on the tabletop. In FIG. 13, the background includes a vertical surface, a barn wall, that appears to support the invitation and reply form by the invitation and reply form hanging on the barn wall. In FIG. 14, the background includes a landscape, and the invitation and reply form appear levitated in front of the landscape.

The present method might provide a dynamic digital invitation platform that allows the inviter to utilize existing paper invitation designs and present them on a digital landscape consisting of a photograph of a physical platform, typically a table. The viewport (camera) might scan across the landscape unveiling pieces of the invitation. So in the example of a children's birthday party invitation, the viewer (invitee) might start by seeing a picture of the birthday child laying askew on a table of toys and then the viewport pans (left or right, up or down) to a picture of a paper invitation on the table that shows event details. Then the viewport might scan again and the viewer would then be presented with an opportunity to RSVP.

Another example might use different physical manifestations of the abstraction of the card that provides the details for the party. It could be chalk on a sandwich board or chalkboard, pegged letters on a menu board or lettering on a movie theater marquis. A platform might consist of a movie where the camera pans in 3D space to show different surfaces where the GUI applies the concepts—like a first person film view.

The composite scene, displayed by the second GUI to the invitee, may include interactive content with one or more interactive elements provided by the inviter or provided by the vendor (website). For example, the background might look like the Life board game and a spinner that the end user spins. The composite scene might include the background scene and, in front of (on top of) that would be the invitation, the reply form, and one or more of (i) user image/video, (ii) static ancillary items and (iii) interactive items.

A Technical overview of an example of the scene composition, rendering, and animation techniques might be as follows. In order to achieve photo-realism in our scenes, an invitation renderer (e.g., vendor or inviter) might take photographs of actual blank cards of various shapes and paper types using the identical lighting condition used to shoot our background images. The renderer might then extract out shadow and paper texture from the card photo to create a transparent overlay layer for the card. Using the same templates, the renderer might create clipping paths that crop the rendered cards exactly along the edges of the physical cards. A similar process can be done for in-situ photographs uploaded by the inviter, where the photos are clipped and rotated to be placed on top of a real blank bordered physical photograph. The background, photos, card, greeting texts, clipping path, shadow and texture are then composited into a single scene to be displayed to the invitees. In order to save bandwidth and rendering time, the renderer might use a backend rendering service to pre-generate composite card and email images prior to sending out the invitations. The renderer might generate the images at various resolutions and crop areas to accommodate different devices and screen sizes.

When displaying the invitation to the invitee, the frontend might automatically select the set of pre-generated images closest to the invitee's device screen resolution to minimize the amount of scaling needed, optimizing performance and quality. To help ensure the accuracy of the scene composition and animation anchor frames positions, the renderer might slice background images to 2, 3, or 4 pieces depending on the target device. The slices might be cropped and divided in such a way that the primary elements (the greeting texts on animation start and the card on animation end) are centered on the screen. This might enable the renderer to easily accommodate any reasonable browser window size/ratio gracefully. The renderer might render the desktop, tablet, or mobile guest experience depending on device screen size/ratio.

The components and procedures described above provide examples of elements recited in the claims. They also provide examples of how a person of ordinary skill in the art can make and use the claimed invention. They are described here to provide enablement and best mode without imposing limitations that are not recited in the claims. In some instances in the above description, a term is followed by an alternative or substantially equivalent term enclosed in parentheses.

1. A method comprising:
displaying a scene, by a graphical user interface (GUI) on a display screen of a communication device, wherein the scene includes:
an image of a background,
an image of an invitation in front of the background, and
an image of a reply form in front of the background, and
wherein the displaying includes panning across the scene such that the background and the invitation appear to move along the screen; and
while the reply form is in the scene, receiving input from a recipient of the invitation for the recipient to interact with the reply form to reply to the invitation.

2. The method of claim 1, wherein:
the scene includes an image of a three-dimensional ancillary item in front of the background,
the panning provides a changing field of view (FOV) that spans only a portion of the scene at a time;
the panning causes the ancillary item to leave the FOV; and
the panning causes the invitation to enter the FOV.

3. The method of claim 2, wherein the panning occurs without input by the recipient.

4. The method of claim 2, wherein the panning occurs as a smooth panning motion.

5. The method of claim 2, wherein the displaying includes zooming in on the invitation.

6. The method of claim 2, wherein the recipient interacting includes the recipient selecting a virtual button in the reply form and the recipient entering text into a reply field of the reply form.

7. The method of claim 2, wherein the recipient interacting occurs while the reply form appears remaining in the scene.

8. The method of claim 2, wherein the background appears as a horizontal surface that appears to support the invitation.

9. The method of claim 2, wherein the background appears as a wall.

10. The method of claim 2, wherein the background appears as a landscape.

11. The method of claim 2, wherein the display screen is part of a smart phone or part of a computer screen.

12. The method of claim 2, wherein the image of the background is obtained by taking a photograph of actual invitation card, and extracting out shadow and paper texture from the image of the invitation card.

13. The method of claim 2, further comprising, before displaying the scene:
receiving, by the communication device, a message that includes a link;
receiving, by the communication device, a selection from the recipient of the link; and
the GUI initiating displaying of the scene in response to the selecting of the link;
wherein, from the selection of the link until the appearance of the reply form in the FOV, the display occurs without user input on the communication device.

14. The method of claim 2, wherein the GUI is implemented by program instructions that are stored in and executed by the communication device.

15. The method of claim 2, wherein the GUI is implemented by program instructions that are executed by a remote server to cause displaying of the scene.

16. The method of claim 2, wherein the GUI is implemented on a web browser of the communication device.

17. The method of claim 2, wherein the invitation is to an event, and the scene includes an image of a person for whom the event is made, with the person appearing, during the displaying of the scene, as being present in front of the background.

18. The method of claim 2, wherein the invitation appears as a realistic invitation card made of paper stock.

19. The method of claim 2, wherein the invitation appears to move relative to the background.

20. The method of claim 2, wherein the communication device is of the recipient, and the method further comprises, before the displaying:
receiving, by a GUI on a communication device of an inviter, selections from the inviter for selecting the invitation, the reply form and the background; and
rendering the displayed scene as a composite of the selected invitation and the selected reply form and the selected background.
